(19) United States
(12) Patent Application Publication
(10) Pub. No.: US 2026/0241526 A1
(43) Pub. Date: Aug. 20, 2026

(54) DRIVING TOOL

(71) Applicant: Max Co., Ltd., Tokyo (JP)

(72) Inventors: Hiroshi Tanaka, Tokyo (JP); Kosuke Murakami, Tokyo (JP)

(21) Appl. No.: 19/541,740

(22) Filed: Feb. 17, 2026

(30) Foreign Application Priority Data
Feb. 17, 2025 (JP) 2025-023810

(51) Int. Cl. B25C 1/04

(52) U.S. Cl. CPC B25C 1/042

(57) ABSTRACT

A driving tool includes: a main chamber configured to store compressed air; a striking cylinder configured to move a striking piston in an axial direction along an up-down direction by being supplied with the compressed air from the main chamber; and a main valve portion configured to switch between supplying and not supplying the compressed air to the striking cylinder. The main valve portion includes: a head valve configured to open and close communication between the striking cylinder and the main chamber; and a control chamber configured to control opening and closing of the head valve by intake and exhaust of the compressed air supplied from the main chamber. The control chamber is provided on an outer periphery of the head valve.

### CROSS-REFERENCE TO RELATED APPLICATIONS

The present application claims priority from Japanese Patent Application No. 2025-023810 filed on Feb. 17, 2025, the entire contents of which are incorporated herein by reference.

### TECHNICAL FIELD

The present disclosure relates to a driving tool for driving a consumable into a driven member.

### BACKGROUND ART

A driving tool that operates by an air pressure of compressed air includes a main valve having a head valve for allowing the compressed air to flow into and out of a striking cylinder. In the related art, a configuration in which the head valve is provided on an upper side of a striking cylinder has been proposed (for example, see JPH07-053902Y). Further, a configuration in which a head valve is provided around a striking cylinder, and a control chamber into which compressed air for causing the head valve to operate flows is provided on an upper side of the head valve has been proposed (for example, see JP4650610B).

### SUMMARY

However, in a configuration in which the head valve is provided on the upper side of the striking cylinder, the height of the main valve in an up-down direction along a moving direction of the head valve increases. In addition, in a configuration in which an air chamber into which the compressed air for operating the head valve flows is provided on the upper side of the head valve, the same applies. The height of the main valve in the up-down direction increases.

Illustrative aspects of the present disclosure provide a driving tool that can reduce a height of a main valve portion.

One illustrative aspect of the present disclosure provides a driving tool including: a main chamber configured to store compressed air; a striking cylinder configured to move a striking piston in an axial direction along an up-down direction by being supplied with the compressed air from the main chamber; and a main valve portion configured to switch between supplying and not supplying the compressed air to the striking cylinder. The main valve portion includes: a head valve configured to open and close communication between the striking cylinder and the main chamber; and a control chamber configured to control opening and closing of the head valve by intake and exhaust of the compressed air supplied from the main chamber. The control chamber is provided on an outer periphery of the head valve.

In the present disclosure, in the main valve portion, since the control chamber is formed on the outer periphery of the head valve, a space for providing the control chamber on an upper side of the head valve is unnecessary.

In the present disclosure, in the main valve portion, since the control chamber is formed on the outer periphery of the head valve, the height of the main valve in the up-down direction can be reduced. Therefore, the overall height of the driving tool can be reduced.

### BRIEF DESCRIPTION OF DRAWINGS

Illustrative embodiments of the present disclosure will be described in detail based on the following figures, wherein:

FIG. 1 is a side sectional view illustrating an example of a nail gun according to the present illustrative embodiment;

FIG. 2 is an external side view illustrating the example of the nail gun according to the present illustrative embodiment;

FIG. 3 is a side sectional view of a main part illustrating the example of the nail gun according to the present illustrative embodiment;

FIG. 4 is a sectional perspective view of a main part of a main valve portion illustrating the example of the nail gun according to the present illustrative embodiment;

FIG. 5 is a side sectional view of the main part of the main valve portion illustrating the example of the nail gun according to the present illustrative embodiment;

FIG. 6 is a plan sectional view of a main part of a trigger valve portion illustrating the example of the nail gun according to the present illustrative embodiment;

FIG. 7 is a side sectional view of a main part illustrating an example of operation of the nail gun according to the present illustrative embodiment;

FIG. 8 is a side sectional view of the main part illustrating the example of the operation of the nail gun according to the present illustrative embodiment; and

FIG. 9 is a side sectional view of the main part illustrating the example of the operation of the nail gun according to the present illustrative embodiment.

### DESCRIPTION OF EMBODIMENTS

Hereinafter, an illustrative embodiment of a nail gun as an example of a driving tool of the present invention will be described with reference to the drawings.

### Configuration Example of Nail Gun

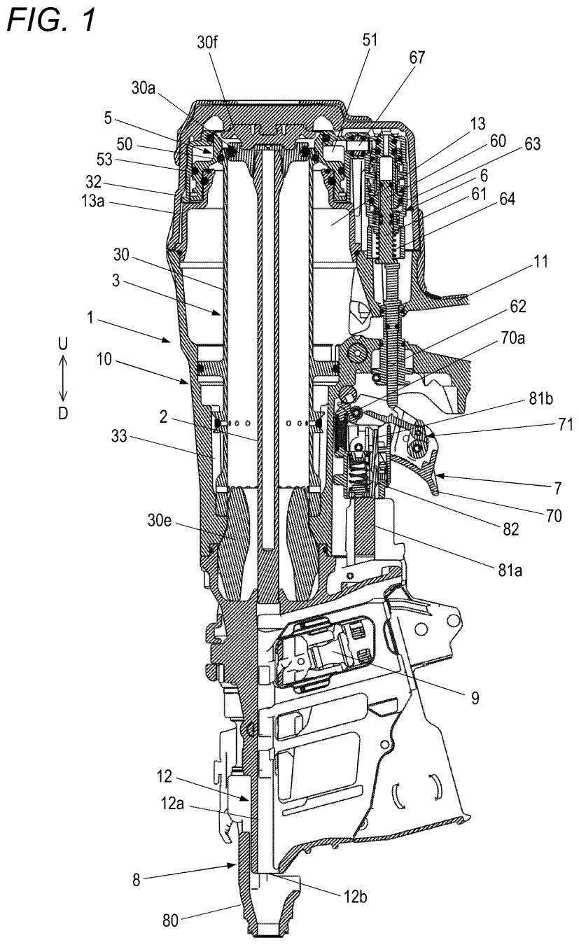

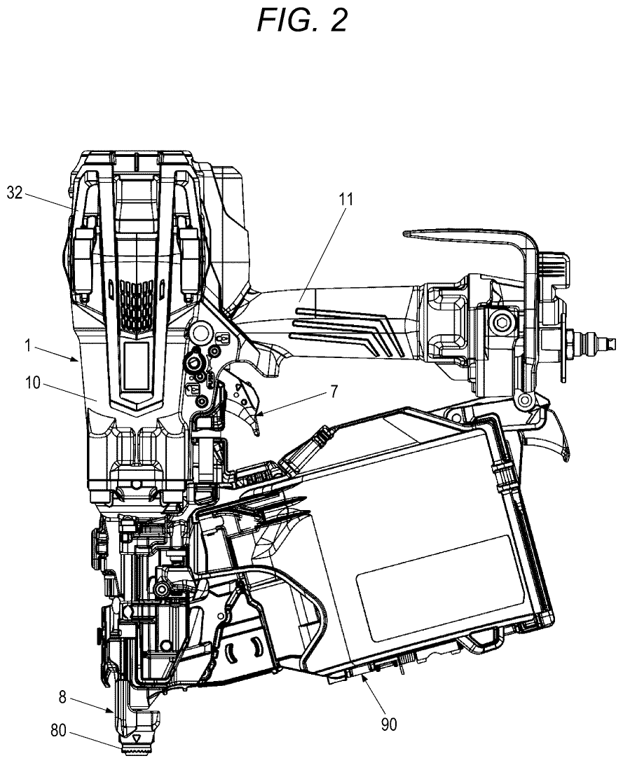

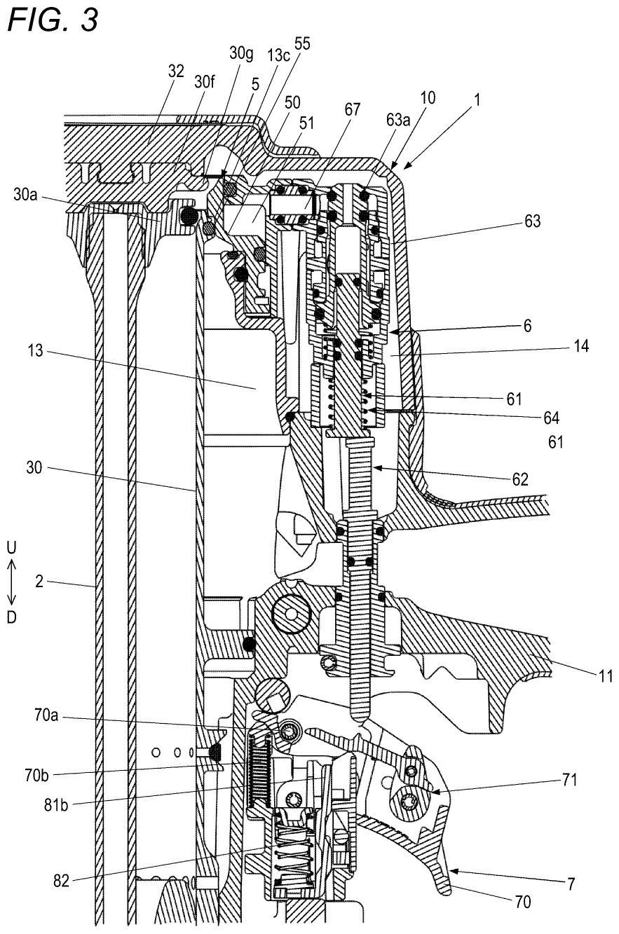

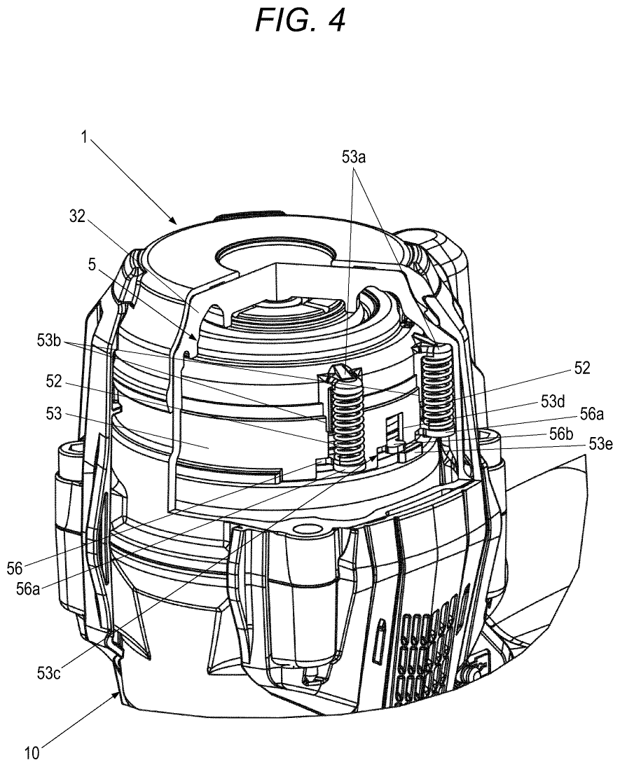

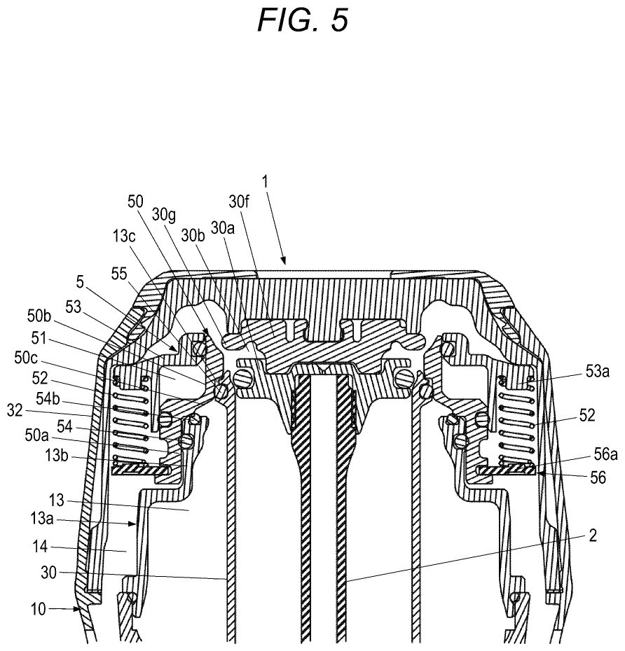

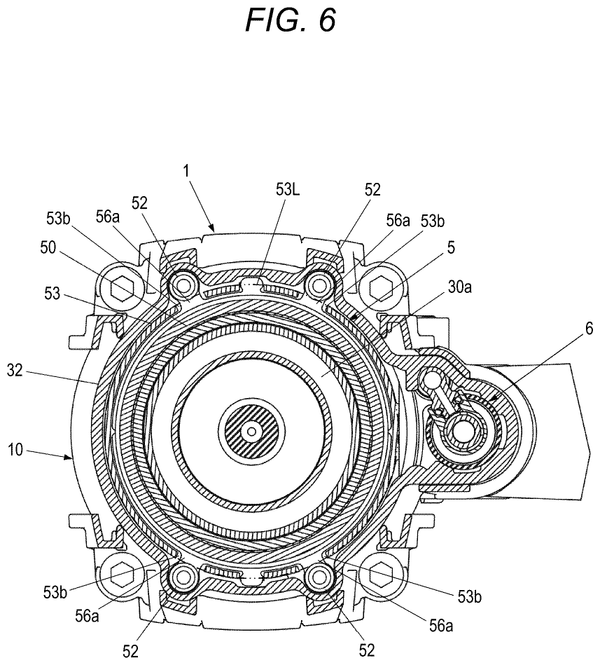

FIG. 1 is a side sectional view illustrating an example of a nail gun according to the present illustrative embodiment, FIG. 2 is an external side view illustrating the example of the nail gun according to the present illustrative embodiment, and FIG. 3 is a side sectional view of a main part illustrating the example of the nail gun according to the present illustrative embodiment. FIG. 4 is a sectional perspective view of a main part of a main valve portion illustrating the example of the nail gun according to the present illustrative embodiment, and FIG. 5 is a side sectional view of the main part of the main valve portion illustrating the example of the nail gun according to the present illustrative embodiment. Further, FIG. 6 is a plan sectional view of a main part of a trigger valve portion illustrating the example of the nail gun according to the present illustrative embodiment.

A nail gun 1 causes a driver 2 to move in an axial direction using air pressure of compressed air. The nail gun 1 drives a nail (not illustrated), which is a consumable, into a driven member by moving the driver 2 in the axial direction.

The nail gun 1 includes a main body 10. The main body 10 extends in an up-down direction along the axial direction of the driver 2. The nail gun 1 has such a form that a person holds it with his or her hand to use it, and includes a handle portion 11 in the main body 10.

In the nail gun 1, the handle portion 11 is provided near the middle along an extension direction of the main body 10. The handle portion 11 extends in a direction intersecting the main body 10 extending in the up-down direction. The exterior of the main body 10 is made of a resin, and the handle portion 11 is integrally formed with the main body 10. The nail gun 1 also includes a nose portion 12. Further, in the nail gun 1, the nose portion 12 is provided on one side along the extension direction of the main body 10.

As illustrated in FIG. 1 and the like, the nail gun 1 is illustrated with the nose portion 12 facing downward, one side along the extension direction of the main body 10, which is a driving direction of the nail (not illustrated), is referred to as a lower side, and the other side along the extension direction of the main body 10 is referred to as an upper side. In the nail gun 1, a down direction is indicated by an arrow D. In the nail gun 1, an up direction opposite to the down direction is indicated by an arrow U. The driver 2 has the axial direction oriented along the up-down direction, and moves downward and upward.

The nose portion 12 includes an injection passage 12a through which the nail is supplied, and an injection port 12b through which the nail supplied to the injection passage 12a is injected.

The injection passage 12a extends along the up-down direction in which the driver 2 moves. The injection port 12b is formed to have an opening on a lower end along an extension direction of the injection passage 12a.

The nail gun 1 includes a main chamber 13 to which compressed air is supplied from an external air compressor (not illustrated), a main chamber housing 13a forming the main chamber 13, and an exhaust chamber 14 forming a part of an exhaust path for exhausting the compressed air to the outside of the nail gun 1. Further, the nail gun 1 includes a driving portion 3 that drives the nail into the driven member. The driving portion 3 includes a striking cylinder 30 that is supplied with the compressed air from the main chamber 13 and causes the driver 2 to move in the axial direction, and a striking piston 30a that moves by the air pressure of the compressed air supplied to the striking cylinder 30.

The striking cylinder 30 is formed of a cylindrical member extending in the up-down direction and having open upper and lower ends, and is attached to the inside of the main body 10.

The striking cylinder 30 is internally provided with the striking piston 30a. The striking piston 30a is formed in a circular plate shape, a cylindrical shape, and the like that can move inside the striking cylinder 30 along the up-down direction. The striking piston 30a is attached in such a shape that the driver 2 protrudes downward. In the striking cylinder 30, a striking cylinder upper chamber 30b is formed in a space on an upper side of the striking piston 30a.

In the nail gun 1, when the striking piston 30a moves in the up-down direction inside the striking cylinder 30, the driver 2 moves in the arrow D direction and the arrow U direction along the axial direction.

Accordingly, in the nail gun 1, the striking piston 30a moves the driver 2 downward as indicated by the arrow D along the axial direction by the air pressure of the compressed air supplied to the striking cylinder 30, and the nail is driven into the driven member.

The striking cylinder 30 includes a lower bumper 30e at a lower end thereof in the axial direction. The lower bumper 30e is formed of an annular elastic body, is exposed to the opening on the lower end of the striking cylinder 30, and has a shape that allows the striking piston 30a to come into contact with it. The striking piston 30a is movable in the down direction to a position in contact with the lower bumper 30e. In the striking piston 30a and the driver 2, a position where the striking piston 30a comes into contact with the lower bumper 30e is a bottom dead center position. The lower bumper 30e is elastically deformable, and the bottom dead center position of the striking piston 30a and the driver 2 moves within a range in which the lower bumper 30e is elastically deformable.

In the nail gun 1, a supply flow path 13c through which the compressed air supplied from the main chamber 13 to the striking cylinder upper chamber 30b of the striking cylinder 30 passes is formed around an outer periphery near the upper end of the striking cylinder 30 between the opening on the upper end of the striking cylinder 30 and the main chamber 13. The striking cylinder 30 includes a supply flow path sealing portion 30c on the outer periphery near the upper end thereof. The supply flow path sealing portion 30c is formed of, for example, an O-ring having elasticity, and is fitted into a groove provided in an outer periphery near the upper end of the striking cylinder 30 in a form in which a part thereof protrudes from an outer peripheral surface of the striking cylinder 30.

The striking cylinder 30 is accommodated in a space inside the main body 10. An upper portion of the main body 10 is open. When the striking cylinder 30 is accommodated, an upper portion of the striking cylinder 30 is exposed upward from the opening on the upper portion.

The nail gun 1 includes a cylinder cap 32. The cylinder cap 32 is formed of a component different from the main body 10, and is attached to the upper portion of the main body 10. When the cylinder cap 32 is attached to the upper portion of the main body 10 in a shape covering the opening on the upper portion of the main body 10, the upper portion of the striking cylinder 30 is accommodated.

The cylinder cap 32 includes an upper bumper 30f on an upper end of the striking cylinder 30 in the axial direction. The upper bumper 30f is formed of a circular elastic body and has a shape that allows the striking piston 30a to come into contact with it. The upper bumper 30f is attached to an inner surface of an upper portion of the cylinder cap 32 and faces the opening on the upper end of the striking cylinder 30 in the axial direction. The striking piston 30a is movable in the up direction to a position in contact with the upper bumper 30f. In the striking piston 30a and the driver 2, a position where the striking piston 30a comes into contact with the upper bumper 30f is a top dead center position. The upper bumper 30f is elastically deformable, and the top dead center position of the striking piston 30a and the driver 2 moves within a range in which the upper bumper 30f is elastically deformable.

The upper bumper 30f includes an exhaust flow path sealing portion 30g on an outer periphery thereof. The exhaust flow path sealing portion 30g is integrally formed on the outer periphery of the upper bumper 30f, which is the elastic body.

The main chamber 13 has a shape in which the main chamber housing 13a covers the periphery of the upper side of the striking cylinder 30, and is provided on the outer periphery of the striking cylinder 30 within the handle portion 11, the main body 10 connected to the handle portion 11, and the main chamber housing 13a. The main chamber housing 13a is attached in the cylinder cap 32 on an upper side of the main body 10. Further, the main chamber housing 13a is formed with a reduced diameter portion 13b in which an inner diameter and an outer diameter of an upper portion are smaller than those of a lower portion. The exhaust chamber 14 is a space extending from the inside of a side portion of the cylinder cap 32 to the inside of the upper portion thereof, and is formed on an outer periphery of the main chamber housing 13a. The exhaust chamber 14 is a flow path connecting the opening on the upper end of the striking cylinder 30 and an exhaust hole (not illustrated) provided in the main body 10, and forms a part of the exhaust path for exhausting the compressed air in the striking cylinder 30 to the outside of the nail gun 1.

The nail gun 1 also includes a blowback chamber 33 that returns the striking piston 30a that has moved to the bottom dead center position to the top dead center position.

The nail gun 1 includes a main valve portion 5 that switches between supplying and not supplying the compressed air to the striking cylinder 30, a trigger valve portion 6 that causes the main valve portion 5 to operate, and a trigger portion 7 that causes the trigger valve portion 6 to operate. The nail gun 1 also includes a contact portion 8 that causes the trigger valve portion 6 to be operable in cooperation with the operation of the trigger portion 7. Further, the nail gun 1 includes a feeding portion 9 that feeds the nail (not illustrated), which is a consumable, to the nose portion 12, and a magazine 90 that accommodates the nail fed by the feeding portion 9.

The main valve portion 5 includes a head valve 50 that opens and closes communication between the main chamber 13 and the striking cylinder 30, a control chamber 51 that controls opening and closing of the head valve 50 by exhaust of the compressed air, and main valve biasing members 52 that bias the head valve 50. Further, the main valve portion 5 includes a main valve housing 53 that supports the head valve 50 and the like.

The head valve 50 is provided around the reduced diameter portion 13b of the main chamber housing 13a and around the vicinity of the upper end of the striking cylinder 30. The main valve housing 53 has a shape covering an outer periphery of the head valve 50. The head valve 50 is attached to the inside of the main valve housing 53 and supported to be movable in the up-down direction with respect to the main valve housing 53. In the main valve portion 5, the control chamber 51 is provided inside the main valve housing 53. When the head valve 50 is attached to the inside of the main valve housing 53, the control chamber 51 is formed inside the main valve housing 53 and around the head valve 50.

The main valve portion 5 includes a first main valve sealing portion 54 that seals communication between the main chamber 13 and the exhaust chamber 14. The first main valve sealing portion 54 is formed of, for example, an O-ring having elasticity, and is fitted into a groove portion formed in an outer peripheral surface of the reduced diameter portion 13b of the main chamber housing 13a.

Further, the main valve portion 5 includes a second main valve sealing portion 55 that seals communication between the striking cylinder upper chamber 30b and the main chamber 13. The second main valve sealing portion 55 is formed of, for example, an O-ring having elasticity, and is fitted into a groove portion formed in the outer peripheral surface of the striking cylinder 30. Since the main chamber housing 13a is provided around the striking cylinder 30, an outer diameter of the striking cylinder 30 is smaller than an outer diameter of the reduced diameter portion 13b of the main chamber housing 13a. Accordingly, the second main valve sealing portion 55 is provided inside the first main valve sealing portion 54. The second main valve sealing portion 55 is provided near the upper end of the striking cylinder 30 to seal the communication between the striking cylinder upper chamber 30b and the main chamber 13.

Further, the main valve portion 5 includes a third main valve sealing portion 54b that seals the communication between the main chamber 13 and the exhaust chamber 14. The third main valve sealing portion 54b is formed of, for example, an O-ring having elasticity, and is fitted into a groove portion formed in an upper end surface of the reduced diameter portion 13b of the main chamber housing 13a. The first main valve sealing portion 54, the second main valve sealing portion 55, and the third main valve sealing portion 54b may be configured such that an O-ring or the like is fitted into a groove provided in the inner surface of the head valve 50, and the O-ring is in contact with the striking cylinder 30 or the main chamber housing 13a.

An inner diameter of a lower portion of the head valve 50 is adjusted to the outer diameter of the reduced diameter portion 13b of the main chamber housing 13a such that the reduced diameter portion 13b of the main chamber housing 13a is placed inside the lower portion thereof. An inner diameter of an upper portion of the head valve 50 is adjusted to the outer diameter of the striking cylinder 30 such that the striking cylinder 30 is placed inside the upper portion thereof. The outer diameter of the reduced diameter portion 13b of the main chamber housing 13a is larger than the outer diameter of the striking cylinder 30. Accordingly, the head valve 50 is formed such that the inner diameter and an outer diameter of the upper portion are smaller than those of the lower portion, and an enlarged valve diameter portion 50a, which is the lower portion, and a reduced valve diameter portion 50b, which is the upper portion, are formed. In the head valve 50, a pressure receiving surface 50c that receives the air pressure of the compressed air supplied from the main chamber 13 is formed of a surface such as an inclined surface connecting the enlarged valve diameter portion 50a to the reduced valve diameter portion 50b. Further, in the main valve portion 5, the control chamber 51 is formed inside the main valve housing 53 around the reduced valve diameter portion 50b of the head valve 50.

The first main valve sealing portion 54 comes into contact with an inner surface of the enlarged valve diameter portion 50a in the head valve 50, thereby sealing the communication between the main chamber 13 and the exhaust chamber 14. Further, the second main valve sealing portion 55 comes into contact with an inner surface of the reduced valve diameter portion 50b in the head valve 50, thereby sealing the communication between the main chamber 13 and the supply flow path 13c, and between the main chamber 13 and the striking cylinder upper chamber 30b. Further, the third main valve sealing portion 54b comes into contact with a plane formed on a part of the pressure receiving surface 50c in the head valve 50, thereby sealing the communication between the main chamber 13 and the exhaust chamber 14.

The main valve biasing member 52 is an example of a main valve biasing portion, and is formed of, for example, a coil spring. The main valve biasing member 52 is provided outside the main valve housing 53, specifically, outside a virtual line 53L connecting outer peripheral surfaces of the main valve housing 53 in a circumferential direction as illustrated in FIG. 6. That is, the main valve biasing member 52 is provided outside an outer peripheral side of the control chamber 51 formed outside the reduced valve diameter portion 50b. Accordingly, the main valve biasing member 52 is provided in the exhaust chamber 14 formed outside the main valve housing 53. The main valve biasing member 52 is provided outside the main valve housing 53, and is therefore provided on the outer periphery of the striking cylinder 30 and further on the outer periphery of the head valve 50.

The main valve biasing member 52 biases the head valve 50 in the closing direction in the present example in order to prevent the head valve 50 from stopping halfway due to the balance between the force pushing the head valve 50 from above and the force pushing the head valve 50 from below due to the balance of the air pressure of the compressed air during the operation of the head valve 50. Further, by biasing the head valve 50 in the closing direction by the main valve biasing member 52, when a hose (not illustrated) for supplying the compressed air is removed from the nail gun 1 in a state in which the head valve 50 is open, the head valve 50 is closed to prevent malfunction.

The main valve portion 5 includes biasing member support portions 53a that support the main valve biasing members 52. The biasing member support portion 53a protrudes outward from an outer periphery of the main valve housing 53 and supports an upper end portion, which is one end portion of the main valve biasing member 52, on the main valve housing 53.

The main valve portion 5 includes base portions 56 that support the main valve biasing members 52 on the head valve 50. The base portion 56 is fitted into a groove portion formed in the outer periphery of the enlarged valve diameter portion 50a, and the head valve 50 and the base portion 56 are attached to be relatively rotatable in the circumferential direction. Accordingly, the head valve 50 to which the base portion 56 is attached is rotatably supported in the circumferential direction with respect to the main valve housing 53.

The base portion 56 includes a biasing member engaging portion 56a with which the main valve biasing member 52 is engaged. The biasing member engaging portion 56a protrudes outward from the outer periphery of the main valve housing 53 and supports a lower end portion, which is the other end portion of the main valve biasing member 52, on the head valve 50.

The main valve portion 5 includes rotation restricting portions 53b that restrict rotation of the base portion 56. The rotation restricting portion 53b is formed of a groove penetrating from an inner periphery to an outer periphery of the main valve housing 53 and extending from a lower end of the main valve housing 53 in the up-down direction along a moving direction of the head valve 50. The rotation restricting portion 53b has an inner width slightly wider than an outer width of the biasing member engaging portion 56a, allowing the biasing member engaging portion 56a to enter and to move in the up-down direction along the rotation restricting portion 53b.

Accordingly, the head valve 50 is supported so as to be movable in the up-down direction with the biasing member engaging portion 56a guided by the rotation restricting portion 53b in a state where the rotation of the base portion 56 with respect to the main valve housing 53 is prevented by the biasing member engaging portion 56a entering the rotation restricting portion 53b. Therefore, the biasing member engaging portion 56a of the base portion 56 is prevented from deviating in the circumferential direction with respect to the biasing member support portion 53a of the main valve housing 53, and the main valve biasing member 52 is prevented from falling or bending. Further, since the head valve 50 is rotatable with respect to the base portion 56, even when the base portion 56 is restricted from rotating with respect to the main valve housing 53, the head valve 50 to which the base portion 56 is attached is supported so as to be rotatable in the circumferential direction with respect to the main valve housing 53. Accordingly, even when the head valve 50 rotates in the circumferential direction, since the base portion 56 does not rotate, a load due to the rotation of the head valve 50 is prevented from being applied to the rotation restricting portion 53b. Therefore, an increase in sliding resistance when the head valve 50 moves up and down is prevented. In a rotation restricting portion, for example, a groove extending up and down may be provided in an inner wall of the cylinder cap 32 forming an inner wall of the exhaust chamber 14 facing the biasing member engaging portion 56a of the base portion 56. Further, the rotation restricting portion may be implemented by both the rotation restricting portion 53b and the groove formed in the inner wall of the cylinder cap 32.

Further, the main valve portion 5 includes a disassembly restricting portion 53c that restricts disassembly of the base portion 56 and the head valve 50 with respect to the main valve housing 53. The disassembly restricting portion 53c is formed by providing a groove 53d penetrating from the inner periphery to the outer periphery of the main valve housing 53 and extending from the lower end of the main valve housing 53 in the up-down direction along the moving direction of the head valve 50, and an abutting portion 53e protruding from a lower end of the groove 53d along the circumferential direction of the main valve housing 53.

The base portion 56 includes a disassembly restricted portion 56b that restricts disassembly of the base portion 56 and the head valve 50 with respect to the main valve housing 53. The disassembly restricting portion 53c has an inner width slightly wider than an outer width of the disassembly restricted portion 56b, allowing the disassembly restricted portion 56b to move in the up-down direction along the groove 53d. Further, the abutting portion 53e of the disassembly restricting portion 53c protrudes toward a movement path of the disassembly restricted portion 56b.

Accordingly, the head valve 50 is supported so as to be movable in the up-down direction in a state where the deviation of the base portion 56 from the main valve housing 53 is prevented by the entry of the disassembly restricted portion 56b into the disassembly restricting portion 53c. Therefore, the base portion 56 and the head valve 50 are prevented from being disassembled from the main valve housing 53.

The main valve housing 53 to which the head valve 50 and the main valve biasing member 52 are assembled is accommodated in the cylinder cap 32 and attached to the upper portion of the main body 10. Accordingly, in the main valve portion 5, the head valve 50 is provided on the upper portion in the main body 10. Further, in the main valve portion 5, the control chamber 51 is provided in the upper portion of the main body 10 and around the head valve 50.

In the main valve portion 5, when the head valve 50 moves downward, the reduced valve diameter portion 50b comes into contact with the second main valve sealing portion 55 to close the supply flow path 13c, and the communication between the striking cylinder upper chamber 30b and the main chamber 13 is sealed to bring the striking cylinder 30 and the main chamber 13 into a non-communicating state. Further, in the main valve portion 5, when the head valve 50 moves upward, the reduced valve diameter portion 50b is separated from the second main valve sealing portion 55 to open the supply flow path 13c, and brings the striking cylinder upper chamber 30b and the main chamber 13 into communication with each other to bring the striking cylinder 30 and the main chamber 13 into a communicating state.

Further, in the main valve portion 5, when the head valve 50 moves downward, the third main valve sealing portion 54b comes into contact with the plane formed on a part of the pressure receiving surface 50c, and the communication between the main chamber 13 and the exhaust chamber 14 is sealed. Further, in the main valve portion 5, when the head valve 50 moves upward, the head valve 50 comes into contact with the exhaust flow path sealing portion 30g, and a space between the striking cylinder 30 and the exhaust chamber 14 is sealed. Further, in the main valve portion 5, in a state where the head valve 50 is moved downward and a state where the head valve 50 is moved upward, the enlarged valve diameter portion 50a comes into contact with the first main valve sealing portion 54 to seal the communication between the main chamber 13 and the exhaust chamber 14.

The trigger valve portion 6 includes a pilot valve 60 that opens and closes the control chamber 51, a trigger valve upper stem 61 that operates the pilot valve 60, and a trigger valve housing 63 into which the pilot valve 60 and the trigger valve upper stem 61 are inserted so as to be movable in the up-down direction. The nail gun 1 also includes a trigger valve lower stem 62 that operates the trigger valve upper stem 61. The trigger valve portion 6 further includes a trigger valve biasing member 64 that biases the trigger valve upper stem 61 and the trigger valve lower stem 62 via the trigger valve upper stem 61.

In the trigger valve portion 6, the pilot valve 60, the trigger valve upper stem 61, and the trigger valve biasing member 64 are assembled to the trigger valve housing 63, and are provided on an upper side of the main body 10 with respect to the handle portion 11. In the trigger valve portion 6, a trigger valve lower stem 62 is provided between the trigger portion 7 and the trigger valve upper stem 61 and between the main body 10 and the handle portion 11. The pilot valve 60, the trigger valve upper stem 61, and the trigger valve lower stem 62 are supported to be movable in the up-down direction. The trigger valve housing 63 includes an exhaust portion 63a that is opened and closed by the movement of the pilot valve 60 in the up-down direction.

The trigger valve portion 6 includes a connection flow path 67 that connects the trigger valve housing 63 to the control chamber 51 in the main valve housing 53. The connection flow path 67 extends in a lateral direction from an upper end side of the trigger valve housing 63 in the vicinity of the exhaust portion 63a and connects the upper end side of the trigger valve housing 63 to the control chamber 51.

The contact portion 8 includes a contact top 80 protruding downward from the injection port 12b, a first contact arm 81a connected to the contact top 80, and a second contact arm 81b engageable with a contact lever portion 71 (to be described later) of the trigger portion 7. The first contact arm 81a is an example of a contact arm, and is supported by the nose portion 12 so as to be relatively movable in the up-down direction. The second contact arm 81b is an example of the contact arm, and is supported to be movable in the up-down direction relative to the main body 10. In the contact portion 8, the second contact arm 81b is biased by the biasing member 82 in the down direction, which is a direction in which the contact top 80 protrudes downward from the injection port 12b. Accordingly, in the contact portion 8, the contact top 80 is pressed against the driven member, so that the first contact arm 81a pushes up the second contact arm 81b, and the second contact arm 81b moves upward relative to the main body 10. The first contact arm 81a and the second contact arm 81b may be integrally formed.

The trigger portion 7 includes a trigger lever 70. The trigger lever 70 extends from the main body 10 along the handle portion 11, and an end portion thereof on a main body 10 side is supported to be rotatable with respect to the main body 10 about a shaft portion 70a as a fulcrum. The trigger portion 7 includes a biasing member 70b that biases the trigger lever 70. The biasing member 70b is formed of, for example, a coil spring, and an end portion of the trigger lever 70 on a side extending from the main body 10 along the handle portion 11 is biased in a direction away from the handle portion 11.

The trigger portion 7 includes the contact lever portion 71. The contact lever portion 71 is rotatably supported by the trigger lever 70 about the shaft portion 73a as a fulcrum. A tip end portion of the contact lever portion 71 is located on a movement path of the second contact arm 81b by the operation in which the second contact arm 81b moves upward relative to the main body 10. A portion of the contact lever portion 71 between the tip end portion and the shaft portion 73a faces the trigger valve lower stem 62. Accordingly, the contact lever portion 71 is engageable with the second contact arm 81b and the trigger valve lower stem 62 of the trigger valve portion 6.

### Operation Example of Nail Gun

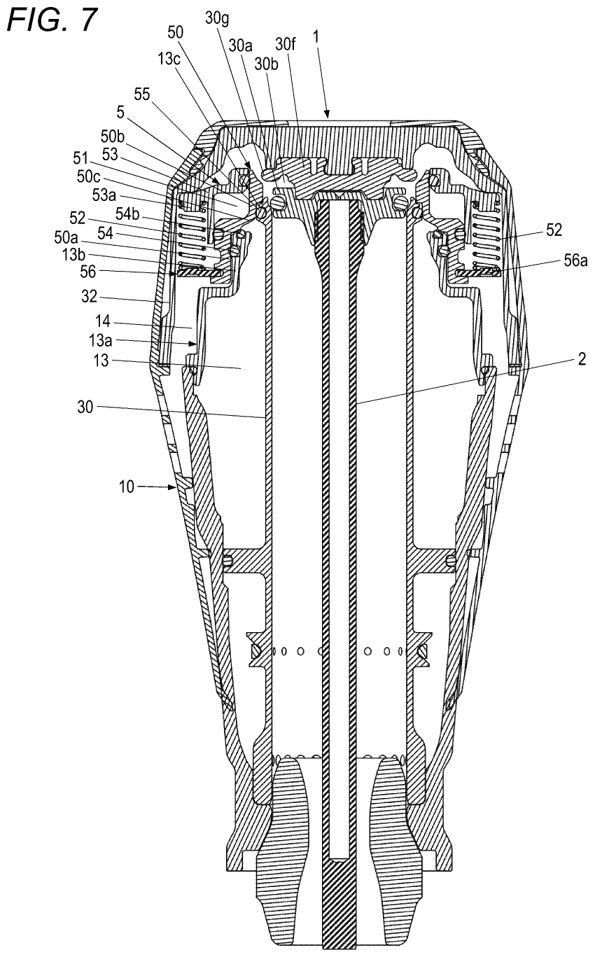

FIGS. 7 to 9 are side sectional views of a main part illustrating an example of operation of the nail gun according to the present illustrative embodiment. Next, the operation of the nail gun 1 will be described.

In a standby state illustrated in FIG. 7, the main valve portion 5 supplies the compressed air from the main chamber 13 to the control chamber 51 via the trigger valve portion 6 illustrated in FIG. 1 and the like. Accordingly, in the main valve portion 5, the head valve 50 moves downward by the air pressure of the compressed air and the biasing of the main valve biasing member 52, and the communication between the main chamber 13 and the striking cylinder 30 is closed.

In the main valve portion 5, when the head valve 50 moves downward to a position where the communication between the main chamber 13 and the striking cylinder 30 is closed, the head valve 50 is in contact with the first main valve sealing portion 54, thereby sealing the communication between the main chamber 13 and the exhaust chamber 14. Further, in the main valve portion 5, the head valve 50 is in contact with the second main valve sealing portion 55, thereby sealing the communication between the striking cylinder upper chamber 30b and the main chamber 13.

An operator pulls the trigger lever 70 illustrated in FIG. 1 and the like from the standby state illustrated in FIG. 7. Further, in a state in which the trigger lever 70 is pulled, the operator presses the contact top 80 against the driven member, and moves the nail gun 1 in a direction approaching the driven member. When the contact top 80 is pressed against the driven member, the second contact arm 81b moves upward relative to the main body 10.

When the second contact arm 81b moves upward relative to the main body 10, the second contact arm 81b comes into contact with the contact lever portion 71 and pushes the contact lever portion 71 toward the trigger valve lower stem 62. Accordingly, the contact lever portion 71 moves the trigger valve lower stem 62 upward relative to the main body 10.

In the trigger valve portion 6, when the trigger valve lower stem 62 moves upward relative to the main body 10, the trigger valve upper stem 61 is pushed by the trigger valve lower stem 62 and moves upward relative to the main body 10.

When the second contact arm 81b moves upward relative to the main body 10, and the trigger valve lower stem 62 and the trigger valve upper stem 61 move upward relative to the main body 10 to an operation position, the trigger valve portion 6 is in a sign ON state in which the trigger valve portion 6 is operable. When the trigger valve upper stem 61 moves to the operation position, the compressed air is exhausted from the trigger valve lower chamber formed on a lower side of the pilot valve 60 to the exhaust chamber 14, and the pilot valve 60 moves downward. When the pilot valve 60 moves downward, the exhaust portion 63a opens. Accordingly, the compressed air passes through the connection flow path 67 from the control chamber 51 and is exhausted to the exhaust chamber 14.

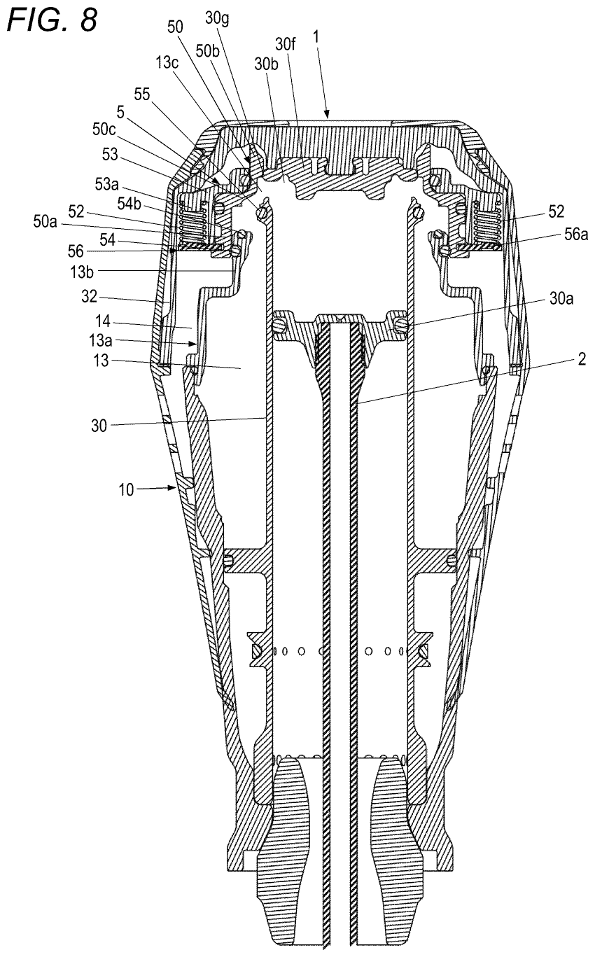

When the compressed air is exhausted from the control chamber 51, as illustrated in FIG. 8, the head valve 50 is moved upward by the air pressure of the compressed air in the main chamber 13. In the main valve portion 5, when the head valve 50 moves upward, the head valve 50 is separated from the second main valve sealing portion 55 to open the supply flow path 13c, and brings the striking cylinder upper chamber 30b and the main chamber 13 into communication with each other to bring the striking cylinder 30 and the main chamber 13 into a communicating state. Further, in the main valve portion 5, when the head valve 50 moves upward, the head valve 50 comes into contact with the exhaust flow path sealing portion 30g, and a space between the striking cylinder 30 and the exhaust chamber 14 is sealed. Further, in the main valve portion 5, the communication between the main chamber 13 and the exhaust chamber 14 is sealed by the enlarged valve diameter portion 50a being in contact with the first main valve sealing portion 54. Accordingly, the compressed air is supplied from the main chamber 13 to the striking cylinder upper chamber 30b of the striking cylinder 30, and the striking piston 30a moves downward. Accordingly, the nail (not illustrated) is driven out.

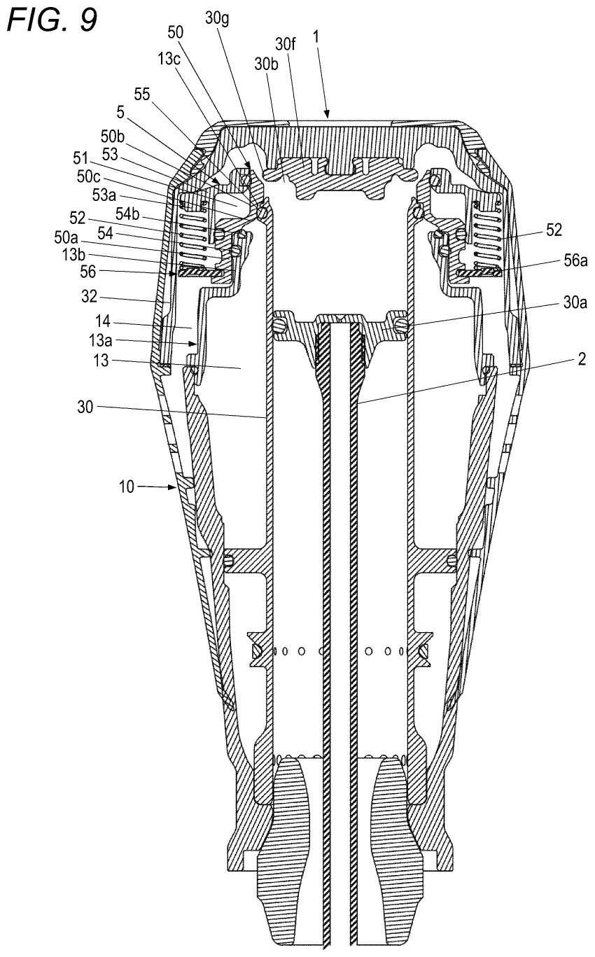

In a return operation illustrated in FIG. 9, in the main valve portion 5, the compressed air is supplied from the main chamber 13 to the control chamber 51 via the trigger valve portion 6 illustrated in FIG. 1 and the like. Accordingly, in the main valve portion 5, the head valve 50 moves downward by the air pressure of the compressed air and the biasing of the main valve biasing member 52, the head valve 50 comes into contact with the second main valve sealing portion 55, the supply flow path 13c is closed, and the communication between the striking cylinder upper chamber 30b and the main chamber 13 is sealed. Further, in the main valve portion 5, when the head valve 50 moves downward, the third main valve sealing portion 54b comes into contact with the plane formed on a part of the pressure receiving surface 50c, thereby sealing the communication between the main chamber 13 and the exhaust chamber 14.

Next, action and effects of the nail gun 1 will be described. As described above, in the head valve 50, the inner diameter of the enlarged valve diameter portion 50a is adjusted to the outer diameter of the reduced diameter portion 13b of the main chamber housing 13a such that the reduced diameter portion 13b of the main chamber housing 13a is placed inside the enlarged valve diameter portion 50a. Further, in the head valve 50, the inner diameter of the reduced valve diameter portion 50b is adjusted to the outer diameter of the striking cylinder 30 such that the striking cylinder 30 is placed inside the reduced valve diameter portion 50b. In this configuration, the main valve portion 5 is provided with the head valve 50 around the striking cylinder 30 and around the reduced diameter portion 13b of the main chamber housing 13a.

Since the outer diameter of the striking cylinder 30 is smaller than the outer diameter of the reduced diameter portion 13b of the main chamber housing 13a, the second main valve sealing portion 55 in contact with the reduced valve diameter portion 50b is provided inside the first main valve sealing portion 54.

In the main valve portion 5, the reduced valve diameter portion 50b of the head valve 50 is in contact with the second main valve sealing portion 55, thereby sealing the communication between the striking cylinder upper chamber 30b and the main chamber 13. Further, in the main valve portion 5, the control chamber 51 is formed inside the main valve housing 53 around the reduced valve diameter portion 50b of the head valve 50. Accordingly, the height of the main valve portion 5 in the up-down direction can be reduced.

The second main valve sealing portion 55 is provided near the upper end of the striking cylinder 30 to seal the communication between the striking cylinder upper chamber 30b and the main chamber 13, and an upper end portion of the striking cylinder 30 opens when the head valve 50 is separated from the second main valve sealing portion 55. Accordingly, a flow path length from the main chamber 13 to the striking cylinder 30 can be shortened, and an operation response of the striking piston 30a is improved.

Further, in the main valve portion 5, the main valve biasing member 52 is provided outside the main valve housing 53 and outside the control chamber 51 formed outside the reduced valve diameter portion 50b. Accordingly, the main valve biasing member 52 is provided in the exhaust chamber 14 formed outside the main valve housing 53, and the main valve biasing member 52 is not provided in the control chamber 51. In the configuration in which the main valve biasing member is provided in the control chamber, when the main valve biasing member is a coil spring, a space on an inner diameter side of the coil spring and between spring wires will be unnecessary volume. On the other hand, since the main valve biasing member 52 is not provided in the control chamber 51, the unnecessary volume of the control chamber 51 is reduced as compared with the case where the main valve biasing member is provided in the control chamber, the decompression time from the air pressure of the compressed air to the atmospheric pressure is shortened, and an opening speed of the head valve 50 is increased. Accordingly, the operation response of the striking piston 30a becomes faster. Therefore, the operation response of the striking operation after the sign is turned on is improved.

In the main valve portion, a sealing member for storing the compressed air or a sealing portion such as a surface with which the sealing member comes into contact moves. Therefore, it is necessary to ensure that the main valve biasing member does not interfere with the sealing portion. However, in the configuration in which the main valve biasing member is provided inside the main valve housing, since the main valve biasing member is provided at a position close to the sealing portion, there is a large restriction on the arrangement of the main valve biasing member. On the other hand, since the main valve biasing member 52 is provided outside the main valve housing 53, the degree of freedom in the position where the main valve biasing member 52 is provided, the number of main valve biasing members 52, an operation amount of the main valve biasing member 52, and the like is increased. Further, even if the main valve biasing member 52 is damaged, since the sealing portion such as the head valve 50 is provided inside the main valve housing 53, damage to the sealing portion in the main valve housing 53 can be prevented. Further, the head valve 50 is rotatable in the circumferential direction with respect to the base portion 56, the rotation of the base portion 56 is restricted by the biasing member engaging portion 56a being guided by the rotation restricting portion 53b of the main valve housing 53, and the main valve biasing member 52 is accommodated in the recessed portion provided in the outer wall of the main valve housing 53, so that even when the head valve 50 rotates, the main valve biasing member 52 can be prevented from falling.

What is claimed is:

1. A driving tool comprising:
a main chamber configured to store compressed air;
a striking cylinder configured to move a striking piston in an axial direction along an up-down direction by being supplied with the compressed air from the main chamber; and
a main valve portion configured to switch between supplying and not supplying the compressed air to the striking cylinder, the main valve portion including:
a head valve configured to open and close communication between the striking cylinder and the main chamber; and
a control chamber configured to control opening and closing of the head valve by intake and exhaust of the compressed air supplied from the main chamber,
wherein the control chamber is provided on an outer periphery of the head valve.

2. The driving tool according to claim 1, further comprising:
a main body extending in the up-down direction;
a cylinder cap attached to the main body and configured to cover an upper side of the main body;
a main chamber housing configured to cover a periphery of the striking cylinder and form the main chamber; and
an exhaust chamber formed by a space connected from an inner side of a side portion of the cylinder cap to an inner side of an upper portion thereof, the exhaust chamber being formed on an outer periphery of the main chamber housing and forming a part of an exhaust flow path for exhausting the compressed air to an outside,
wherein the head valve is provided on the outer periphery of the main chamber housing,
wherein the main valve portion includes a first main valve sealing portion configured to seal communication between the main chamber and the exhaust chamber, and
wherein the first main valve sealing portion is provided on the outer periphery of the main chamber housing.

3. The driving tool according to claim 2,
wherein the main chamber housing is formed with a reduced diameter portion in which an inner diameter and an outer diameter of an upper portion are smaller than those of a lower portion, and
wherein the first main valve sealing portion is provided on an outer periphery of the reduced diameter portion.

4. The driving tool according to claim 2,
wherein an upper end of the striking cylinder is open, a striking cylinder upper chamber is formed on an upper side of the striking piston, and
wherein the main valve portion includes a second main valve sealing portion configured to seal communication between the striking cylinder upper chamber and the main chamber, and the second main valve sealing portion is provided radially inside the first main valve sealing portion.

5. The driving tool according to claim 4, wherein the second main valve sealing portion is provided on an outer periphery of the striking cylinder near the upper end of the striking cylinder.

6. The driving tool according to claim 1,
wherein the head valve is formed with a reduced valve diameter portion in which an inner diameter and an outer diameter of an upper portion are smaller than those of a lower portion, and
wherein the control chamber is provided on an outer periphery of the reduced valve diameter portion.
